(19) United States
(12) Patent Application Publication
(10) Pub. No.: US 2026/0331582 A1
(43) Pub. Date: Oct. 22, 2026

(54) ELECTROLYTE, LITHIUM-ION BATTERY, AND ELECTRIC DEVICE

(71) Applicant: HUIZHOU LIWINON NEW ENERGY TECHNOLOGY CO., LTD, Huizhou, Guangdong (CN)

(72) Inventors: Chang ZHENG, Huizhou, Guangdong (CN); Wei XIONG, Huizhou, Guangdong (CN); Jianglan LI, Huizhou, Guangdong (CN); Xinzhe YANG, Huizhou, Guangdong (CN); Yanhua ZHU, Huizhou, Guangdong (CN); Shengben WU, Huizhou, Guangdong (CN)

(21) Appl. No.: 19/469,102

(22) PCT Filed: Dec. 14, 2023
(86) PCT No.: PCT/CN2023/138662

§ 371 Date: Sep. 25, 2025

(30) Foreign Application Priority Data
Oct. 24, 2023 (CN) 202311380910.2

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0034; H01M 2300/004

(57) ABSTRACT

This application provides an electrolyte, a lithium-ion battery, and an electric device. The electrolyte includes a solvent, a lithium salt, and an additive. The solvent includes a fluoroether, a carbonate compound, and a carboxylic ester in a mass ratio of (10-20):(40-65):(20-45). The additive includes a first additive, and the first additive is a tetranitrile compound represented by formula I. Compared with the prior art, a solvent of the electrolyte in this application includes a fluoroether, which enables the formation of a solid electrolyte interphase (SEI) film with improved toughness at a lithium metal anode to improve the stability of an interface at a lithium metal anode. Additionally, a tetranitrile compound is added as an additive, which can effectively enhance the stability of a positive electrode. The tetranitrile compound can play a synergistic role with the fluoroether to effectively balance the transport rate of lithium ions.

### CROSS-REFERENCE TO RELATED APPLICATIONS

This application is a national stage application of PCT/CN2023/138662. This application claims priorities from PCT Application No. PCT/CN2023/138662, filed Dec. 14, 2023, and from the Chinese patent application 202311380910.2 filed Oct. 24, 2023, the content of which are incorporated herein in the entirety by reference.

### TECHNICAL FIELD

The present disclosure belongs to the field of lithium-ion batteries, and specifically relates to an electrolyte, a lithium-ion battery, and an electric device.

### BACKGROUND

Due to large energy density, excellent fast-charging performance, and high safety, lithium-ion batteries are widely used in many fields, such as electric vehicles, electric tools, digital products, and energy storage power stations. In lithium-ion batteries, the most common anode material is currently graphite, which is characterized by a high electronic conductivity, a large lithium-ion diffusion coefficient, a low lithium intercalation potential, abundant raw material availability, and a low cost. However, the maximum energy density of graphite can merely reach 372 mAh/g, which greatly restricts the development of lithium-ion batteries. Therefore, there is an urgent need to develop the next-generation anode materials for lithium batteries.

Lithium metal has a theoretical specific capacity of 3,860 mAh/g and excellent electronic conductivity. Thus, lithium metal can replace graphite to serve as an anode material for lithium-ion batteries. However, due to the presence of local polarization, lithium metal is faced with issues such as dendritic growth during deposition, resulting in dead lithium and low Coulombic efficiency. In severe cases, dendrites may penetrate a separator to cause safety risks. Additionally, a lithium metal negative electrode will undergo a huge volume change during a charge/discharge process, which causes serious damage to a solid electrolyte interphase (SEI) layer and accelerates the consumption of an electrolyte. As a result, the application of lithium metal negative electrodes is remarkably limited.

In view of this, it is necessary to provide a technical solution to mitigate the above problems.

### SUMMARY

A first objective of the present disclosure is to provide an electrolyte in view of the deficiencies in the prior art. This electrolyte can mitigate the problems that lithium dendrites are easily generated in the current lithium metal negative electrode-based lithium-ion batteries and an SEI film is destructed due to a volume change of the lithium metal, thereby enhancing the cycle life and safety of lithium metal negative electrode-based lithium-ion batteries.

To achieve the first objective, the present disclosure provides the following technical solutions:

An electrolyte comprises a lithium salt, a solvent, and an additive, wherein
the solvent includes a fluoroether, a carbonate compound, and a carboxylic ester in a mass ratio of (10-20):(40-65):(20-45);
the additive comprises a first additive, and the first additive is a tetranitrile compound represented by formula I:

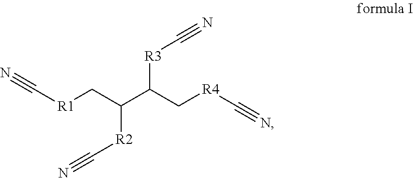

wherein R₁, R₂, R₃, and R₄ are each independently selected from the group consisting of substituted or unsubstituted C₁-C₁₀ alkyl or alkoxy, C₂-C₁₀ alkenyl or alkenoxy, C₂-C₁₀ alkynyl or alkynoxy, and a group with one or more heteroatoms of N, S, and O, and when there is a substitution, a substituent is a fluorine (F) atom; and
when a mass proportion of the fluoroether in the electrolyte is a %, a mass proportion of the carbonate compound in the electrolyte is b %, a mass proportion of the carboxylic ester in the electrolyte is c %, and a mass proportion of the first additive in the electrolyte is d %, the following relational expression is satisfied: (a+b+c)*3%≥d≥(a+b+c)*0.5%.

Preferably, the mass proportion of the fluoroether in the electrolyte is less than the mass proportion of the carboxylic ester in the electrolyte; and the mass proportion of the carboxylic ester in the electrolyte is less than the mass proportion of the carbonate compound in the electrolyte.

Preferably, a sum of the mass proportions of the fluoroether, the carbonate compound, and the carboxylic ester in the electrolyte is greater than or equal to 50%.

Preferably, the carbonate compound is a fluorinated or non-fluorinated carbonate compound; and the carboxylic ester is a fluorinated or non-fluorinated carboxylic ester.

Preferably, the fluoroether has a structural formula of

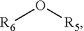

the carboxylic ester has a structural formula of

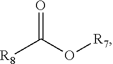

and the carbonate compound has a structural formula of

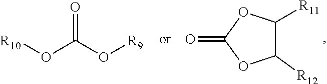

wherein R₅ and R₆ are each independently selected from the group consisting of fluorinated C₁-C₁₀ alkyl or alkoxy, fluorinated C₂-C₁₀ alkenyl or alkenoxy, and fluorinated C₂-C₁₀ alkynyl or alkynoxy; and Ry to R₁₂ are each independently selected from the group consisting of fluorinated or non-fluorinated C₁-C₁₀ alkyl or alkoxy, fluorinated or non-fluorinated C₂-C₁₀ alkenyl or alkenoxy, and fluorinated or non-fluorinated C₂-C₁₀ alkynyl or alkynoxy.

Preferably, the first additive is any one selected from the group consisting of the following structural formulas:

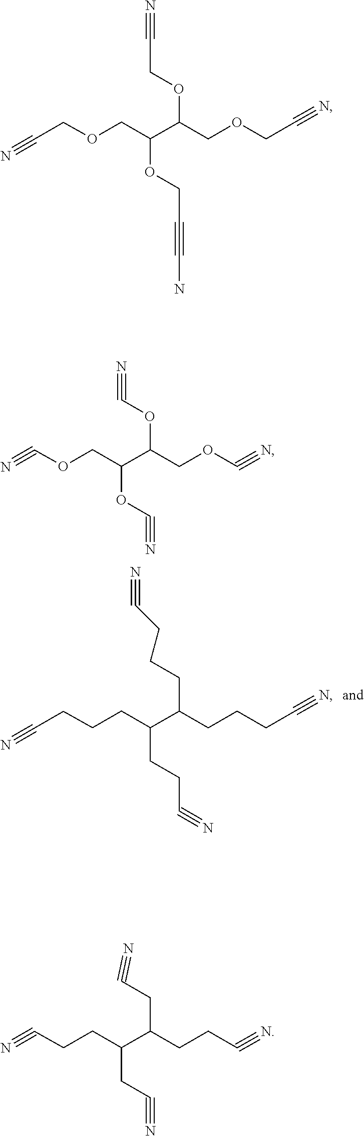

Preferably, the additive further comprises a second additive; the second additive is at least one selected from the group consisting of 1,3-propane sultone (PS), 1,3,2-dioxathiolane-2,2-dioxide (DTD), fluoroethylene carbonate (FEC), tris(trimethylsilyl) borate (TMSB), and tris(trimethylsilyl)phosphate (TMSP); and a mass proportion of the second additive in the electrolyte is 0.1% to 10%.

Preferably, the lithium salt is at least one selected from the group consisting of lithium hexafluorophosphate, lithium difluorophosphate, lithium difluoro (oxalato)phosphate, lithium tetrafluoro (oxalato)phosphate, lithium bis(oxalate) borate, lithium difluorooxalate borate, lithium tetrafluoroborate, lithium bis(trifluoromethanesulfonyl)imide, lithium trifluoromethanesulfonate, lithium perchlorate, and lithium bis(fluorosulfonyl)imide, and a mass proportion of the lithium salt in the electrolyte is 0.1% to 25%.

A second objective of the present disclosure is to provide a secondary battery, comprising a positive electrode, a negative electrode, a separator arranged between the positive electrode and the negative electrode, and an electrolyte, wherein the electrolyte is the electrolyte described above, and the negative electrode is a lithium metal negative electrode.

A third objective of the present disclosure is to provide an electric device comprising the secondary battery described above.

Compared with the prior art, the present disclosure has the following beneficial effects: The solvent of the electrolyte in the present disclosure comprises a fluoroether, which enables the formation of an SEI film with improved toughness at a lithium metal anode and can effectively mitigate the formation of lithium dendrites commonly observed in lithium metal anode materials, thereby improving the stability of an interface at a lithium metal anode. Moreover, a tetranitrile compound is added as an additive. Such a tetranitrile compound exhibits a stronger complexation ability with transition metal ions than the conventional dinitrile and trinitrile additives, which can effectively improve the stability of a positive electrode and enhance the stability of an interface at a negative electrode. The tetranitrile compound can play a synergistic role with the fluoroether to effectively balance the transport rate of lithium ions and improve the cycle life and safety of lithium metal negative electrode-based lithium-ion batteries.

### DETAILED DESCRIPTION OF THE EMBODIMENTS

In order to make the technical solutions and advantages of the present disclosure clear, the present disclosure and beneficial effects thereof will be further described in detail below with reference to specific embodiments, but the embodiments of the present disclosure are not limited thereto.

A first aspect of the present disclosure is to provide an electrolyte, comprising a lithium salt, a solvent, and an additive.

The solvent comprises a fluoroether, a carbonate compound, and a carboxylic ester in a mass ratio of (10-20):(40-65):(20-45).

The additive comprises a first additive. The first additive is a tetranitrile compound represented by formula I:

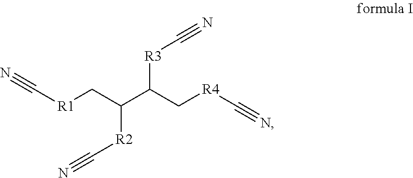

wherein R₁, R₂, R₃, and R₄ are each independently selected from the group consisting of substituted or unsubstituted C₁-C₁₀ alkyl or alkoxy, C₂-C₁₀ alkenyl or alkenoxy, C₂-C₁₀ alkynyl or alkynoxy, and a group with one or more heteroatoms of N, S, and O, and when there is a substitution, a substituent is an F atom.

When a mass proportion of the fluoroether in the electrolyte is a %, a mass proportion of the carbonate compound in the electrolyte is b %, a mass proportion of the carboxylic ester in the electrolyte is c %, and a mass proportion of the first additive in the electrolyte is d %, the following relational expression is satisfied: (a+b+c)*3%≥d≥(a+b+c)*0.5%.

The solvent of the electrolyte comprises a fluoroether. Compared to the conventional non-fluorinated ether solvents (such as dimethyl ether (DME)), the fluoroether can participate in or alter the solvation structure to alter the stability of the solvation structure, such that Li⁺ in the electrolyte is more prone to association with anionic species. The lithium salt additive in the electrolyte can be precipitated on surfaces of positive and negative electrodes, and decomposed to produce interfacial film-forming components such as Li₃PO₄, Li₂CO₃, and LiF, which can enhance the toughness of an SEI film, improve the interfacial stability of a lithium metal anode, and significantly reduce the occurrence of side reactions. The carbonate compound has a high dielectric constant, a high dissociation constant, and a low viscosity, and possesses well-balanced overall performance. The carboxylic ester exhibits a high electronic conductivity and prominent oxidation resistance. As a result, the electrolyte can exhibit improved oxidation resistance while maintaining a low viscosity.

When the mass ratio of the fluoroether, the carbonate compound, and the carboxylic ester is controlled in the range of (10-20):(40-65):(20-45), a content of the fluoroether is neither too high to affect other properties of the electrolyte, nor too low to fail to effectively improve the stability of an SEI film. Consequently, the long cycle life of a lithium metal anode can be ensured. Specifically, the mass ratio of the fluoroether, the carbonate compound, and the carboxylic ester may be 10:40:50, 10:45:45, 10:50:40, 10:55:35, 10:60:30, 10:65:25, 15:40:45, 15:50:35, 15:60:25, 20:40:40, 20:45:35, 20:50:30, and 20:60:20, but is not limited thereto.

In addition, if the mass proportion of the first additive in the electrolyte is d %, the following relational expression is satisfied: (a+b+c)*3%≥d≥(a+b+c)*0.5%. The content of the first additive varies with the contents of the fluoroether, the carbonate compound, and the carboxylic ester. When the above relational expression is satisfied, there is a sufficient amount of the tetranitrile compound to complex with transition metal ions to effectively guarantee the stability of a positive electrode, and the transport rate of lithium ions will not be compromised by too-large impedance due to a too-high content of the tetranitrile compound. The coordination of the tetranitrile compound with the fluoroether solvent in the specified contents can effectively mitigate the generation of lithium dendrites commonly observed in lithium metal anode systems.

Preferably, a sum of the mass proportions of the fluoroether, the carbonate compound, and the carboxylic ester in the electrolyte is greater than or equal to 50%. In this way, there can be a sufficient amount of the tetranitrile compound to complex with transition metal ions, thereby ensuring the stability of a positive electrode. The coordination of the tetranitrile compound with the fluoroether solvent in the specified contents can mitigate the generation of lithium dendrites that easily occurs in lithium metal anode systems, and effectively balance the transport rate of lithium ions in lithium metal negative electrode-based lithium-ion batteries, thereby enhancing the overall performance for batteries.

In some embodiments, the mass proportion of the fluoroether in the electrolyte is less than the mass proportion of the carboxylic ester in the electrolyte; and the mass proportion of the carboxylic ester in the electrolyte is less than the mass proportion of the carbonate compound in the electrolyte. That is, when a mass proportion of the fluoroether in the electrolyte is a %, a mass proportion of the carbonate compound in the electrolyte is b %, and a mass proportion of the carboxylic ester in the electrolyte is c %, a<c and c<b. Specifically, the mass ratio of the fluoroether, the carbonate compound, and the carboxylic ester may be preferably 10:50:40, 10:55:35, 10:60:30, 10:65:25, 15:50:35, 15:60:25, 20:45:35, and 20:50:30, but is not limited thereto.

In some embodiments, the fluoroether has a structural formula of

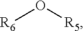

wherein R₅ and R₆ are each independently selected from the group consisting of fluorinated C₁-C₁₀ alkyl or alkoxy, fluorinated C₂-C₁₀ alkenyl or alkenoxy, and fluorinated C₂-C₁₀ alkynyl or alkynoxy. Preferably, the fluoroether at least comprises two fluorine substitutions. More preferably, the fluoroether at least comprises four fluorine substitutions.

Specifically, the fluoroether may be at least one selected from the group consisting of the following structural formulas:

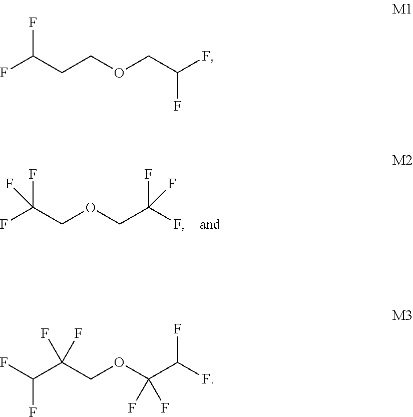 [SMILES: FC(F)CCOCC(F)F ; FC(F)(F)COCC(F)(F)F ; "and" ; FC(F)C(F)(F)COC(F)(F)C(F)F]

In some embodiments, the carbonate compound is a fluorinated or non-fluorinated carbonate compound. The carbonate compound may be a fluorinated or non-fluorinated linear carbonate compound with a structural formula of

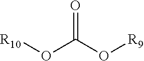

or may be a fluorinated or non-fluorinated cyclic carbonate compound

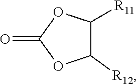

wherein R₉ to R₁₂ are each independently selected from the group consisting of fluorinated or non-fluorinated C₁-C₁₀ alkyl or alkoxy, fluorinated or non-fluorinated C₂-C₁₀ alkenyl or alkenoxy, and fluorinated or non-fluorinated C₂-C₁₀ alkynyl or alkynoxy.

Specifically, the non-fluorinated linear carbonate compound may be at least one selected from the group consisting of ethyl methyl carbonate (EMC), diethyl carbonate (DEC), dimethyl carbonate (DMC), and methyl propyl carbonate (MPC).

The fluorinated linear carbonate compound may be at least one selected from the group consisting of the following structural formulas:

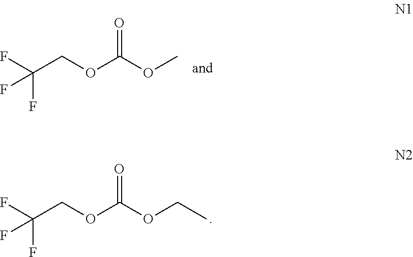

The non-fluorinated cyclic carbonate compound may be at least one selected from the group consisting of ethylene carbonate (EC), propylene carbonate (PC), and butylene carbonate (BC).

The fluorinated cyclic carbonate compound may be at least one selected from the group consisting of the following structural formulas:

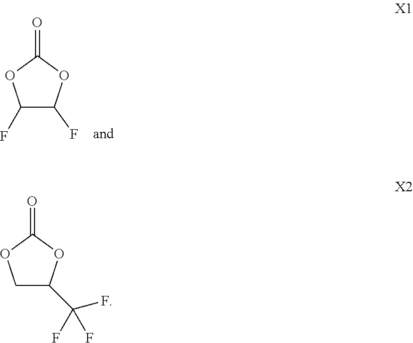 [SMILES: O=C1OC(F)C(F)O1 ; O=C1OCC(C(F)(F)F)O1]

In some embodiments, the carboxylic ester is a fluorinated or non-fluorinated carboxylic ester with a structural formula of

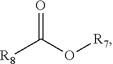

wherein R₇ to R₈ are each independently selected from the group consisting of fluorinated or non-fluorinated C₁-C₁₀ alkyl or alkoxy, fluorinated or non-fluorinated C₂-C₁₀ alkenyl or alkenoxy, and fluorinated or non-fluorinated C₂-C₁₀ alkynyl or alkynoxy.

Specifically, the non-fluorinated carboxylic ester may be at least one selected from the group consisting of methyl formate (MF), propyl propionate (PP), ethyl acetate (EA), ethyl formate (EF), propyl formate (PF), butyl formate (BF), methyl acetate (MA), propyl acetate (PA), methyl propionate (MP), ethyl propionate (EP), ethyl butyrate (EB), propyl butyrate (PB), and γ-butyrolactone (GBL).

The fluorinated carboxylic ester may be at least one selected from the group consisting of the following structural formulas:

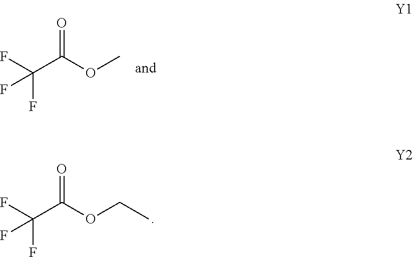

In the electrolyte of the present disclosure, a tetranitrile compound with a structure represented by formula I is also added as an electrolyte additive. The tetranitrile compound with this structure exhibits a stronger complexation ability with transition metal ions than the conventional dinitrile (such as adiponitrile (ADN) and succinonitrile (SN)) and trinitrile additives (such as 1,3,6-hexanetrinitrile (HTCN)). The synergistic action of the tetranitrile compound and the fluoroether solvent in lithium metal negative electrode-based lithium-ion batteries can effectively balance the transport rate of lithium ions, and significantly mitigate the generation of lithium dendrites that easily occurs in lithium metal anode systems, thereby enhancing the cycle life and safety of lithium metal negative electrode-based lithium-ion batteries.

In some embodiments, the first additive is any one selected from the group consisting of the following structural formulas:

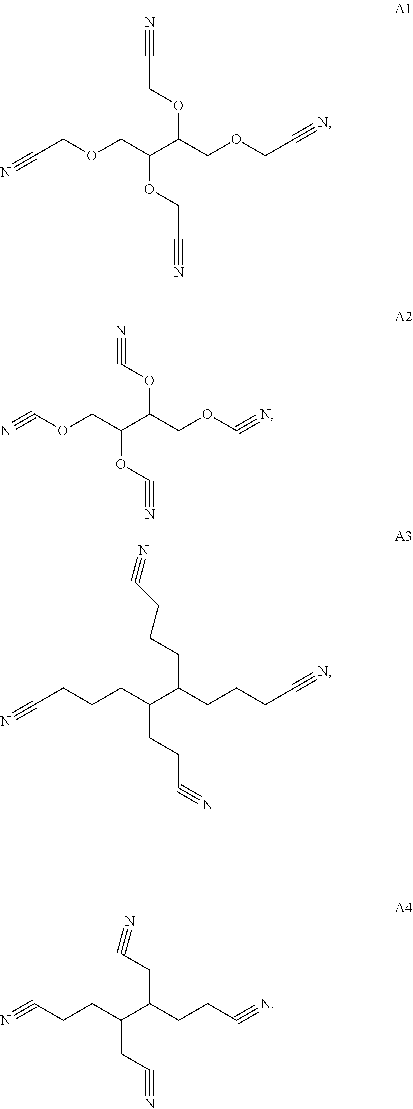

In some embodiments, the additive further comprises a second additive. The second additive is at least one selected from the group consisting of 1,3-propane sultone (PS), 1,3,2-dioxathiolane-2,2-dioxide (DTD), fluoroethylene carbonate (FEC), tris(trimethylsilyl) borate (TMSB), and tris(trimethylsilyl)phosphate (TMSP). A mass proportion of the second additive in the electrolyte is 0.1% to 10%. Preferably, the mass proportion of the second additive in the electrolyte is 3% to 8%.

1,3-propane sultone (PS), as a second additive for both positive and negative electrodes, can improve the cycling performance of a battery and suppress the gas generation during high-temperature storage. 1,3,2-dioxathiolane-2,2-dioxide (DTD), as a second additive for both positive and negative electrodes, can enhance the cycling performance of a battery. Fluoroethylene carbonate (FEC), as a second additive for a negative electrode, can repair a damaged solid electrolyte interphase (SEI) film. Tris(trimethylsilyl)phosphate (TMSP), as a second additive for a negative electrode, can reduce the impedance. When used in combination with a phosphite additive, TMSB can effectively improve the stability of SEI and the cycling performance. TMSP, as a second additive for a negative electrode, can also reduce the impedance and improve the stability of SEI and the cycling performance. Preferably, the inventors have discovered that the use of PS and DTD in combination with the tetranitrile compound is more in line with lithium metal negative electrode-based lithium-ion batteries and enables better electrochemical performance for batteries than the use of the tetranitrile compound with other additives.

In some embodiments, the lithium salt is at least one selected from the group consisting of lithium hexafluorophosphate, lithium difluorophosphate, lithium difluoro (oxalato)phosphate, lithium tetrafluoro (oxalato)phosphate, lithium bis(oxalate) borate, lithium difluorooxalate borate, lithium tetrafluoroborate, lithium bis(trifluoromethanesulfonyl)imide, lithium trifluoromethanesulfonate, lithium perchlorate, and lithium bis(fluorosulfonyl)imide, and a mass proportion of the lithium salt in the electrolyte is 0.1% to 25%. Preferably, the mass proportion of the lithium salt in the electrolyte is 5% to 20%. More preferably, the mass proportion of the lithium salt in the electrolyte is 10% to 18%.

A second aspect of the present disclosure is to provide a secondary battery, comprising a positive electrode, a negative electrode, a separator arranged between the positive electrode and the negative electrode, and an electrolyte, wherein the electrolyte is the electrolyte described above, and the negative electrode is a lithium metal negative electrode.

In some embodiments, the positive electrode comprises a positive-electrode current collector and a positive-electrode active layer coated on at least one surface of the positive-electrode current collector. The positive-electrode active layer further comprises a positive-electrode active material. The positive-electrode active material may comprise, but is not limited to, a chemical formula such as LiₓNiₕCo_{y}M_{z}O_{2-d}N_{d} (wherein 0.95≤x≤1.2, h>0, y≥0, z≥0, h+y+z=1, 0≤d≤1, M is one or a combination of two selected from the group consisting of Mn and Al, and N is one or a combination of two or more selected from the group consisting of F, P, and S). The positive-electrode active material may also comprise, but is not limited to, one or a combination of two or more selected from the group consisting of LiCoO₂, LiNiO₂, LiVO₂, LiCrO₂, LiMn₂O₄, LiCoMnO₄, Li₂NiMn₃O₈, LiNi_{0.5}Mn_{1.5}O₄, LiCoPO₄, LiMnPO₄, LiFePO₄, LiNiPO₄, LiCoFSO₄, CuS₂, FeS₂, MoS₂, NiS, and TiS₂. The positive-electrode active material can also be modified. A method for modifying the positive-electrode active material should be known to those skilled in the art. For example, the positive-electrode active material can be modified by a method such as coating and doping. A material adopted for the modification may comprise, but is not limited to, one or a combination of two or more selected from the group consisting of Al, B, P, Zr, Si, Ti, Ge, Sn, Mg, Ce, and W. The positive-electrode current collector can be made of any material suitable for current collectors of positive electrodes of lithium-ion batteries in the art. For example, the positive-electrode current collector may comprise, but is not limited to, a metal foil, and more specifically, the positive-electrode current collector may comprise, but is not limited to, an aluminum foil.

The separator may be made of any material suitable for separators of lithium-ion batteries in the art. For example, the material may comprise, but is not limited to, one or a combination of two or more selected from the group consisting of polyethylene, polypropylene, polyvinylidene fluoride (PVDF), aramid, polyethylene terephthalate, polytetrafluoroethylene, polyacrylonitrile, polyimide, polyamide, polyester, and a natural fiber.

A third aspect of the present disclosure is to provide an electric device comprising the secondary battery described above.

The electric device may be a vehicle, a mobile phone, a portable device, a notebook computer, a ship, spacecraft, an electric toy, an electric tool, etc. The vehicle may be a fuel vehicle, a gas vehicle, or a new energy vehicle. The new energy vehicle may be a pure electric vehicle, a hybrid vehicle, an extended-range vehicle, etc. The spacecraft comprises a plane, a rocket, a spaceplane, a spaceship, etc. The electric toy comprises a fixed or mobile electric toy, such as a game console, an electric toy car, an electric toy ship, and an electric toy plane. The electric tool comprises a metal cutting electric tool, a grinding electric tool, an assembly electric tool, and an electric tool for a railway, such as an electric drill, an electric grinding machine, an electric wrench, an electric screwdriver, an electric hammer, an electric impact drill, a concrete vibrator, and an electric planer.

To better validate that the electrolyte provided by the present disclosure has excellent performance, the present disclosure and beneficial effects thereof will be described in further detail below with reference to specific examples, but the implementations of the present disclosure are not limited thereto.

### Example 1

An electrolyte comprised a lithium salt, a solvent, and an additive. A specific composition and preparation method of the electrolyte were as follows: In a glove box filled with argon, with a total volume of the solvent as 100%, EC, DEC, PP, and 1,1,2,2-tetrafluoroethyl-2,2,3,3-tetrafluoropropyl ether (TTE, namely, the above structural formula M3) were mixed in a mass ratio of 20:30:40:10 to produce a mixed solution. Lithium hexafluorophosphate (LiPF₆) was added at an amount of 14.5 wt % based on a total weight of the electrolyte slowly to the mixed solution. Based on the total weight of the electrolyte, 0.5 wt % of a tetranitrile compound with a structural formula A1, 0.4 wt % of PS, and 1 wt % of DTD were added. A resulting solution was fully stirred to produce the electrolyte in this example.

With reference to the above composition, compositions and proportions of the solvent, the lithium salt, and the additive were adjusted to produce Examples 2 to 15 and Comparative Examples 1 to 9. The specific compositions were shown in Table 1 below.

TABLE 1

| | Solvent | Lithium salt | Additive |
|---|---|---|---|
| Example 1 | EC:DEC: PP:M3 = | LiPF₆:14.5% | A1:0.5% |
| | 20:30:40:10 | | PS:0.4% |
| | | | DTD:1% |
| Example 2 | EC:DEC: PP:M3 = | LiPF₆:14.5% | A2:0.5% |
| | 20:30:40:10 | | PS:0.4% |
| | | | DTD:1% |
| Example 3 | EC:DEC: PP:M3 = | LiPF₆:14.5% | A3:0.5% |
| | 20:30:40:10 | | PS:0.4% |
| | | | DTD:1% |
| Example 4 | EC:DEC: PP:M3 = | LiPF₆:14.5% | A4:0.5% |
| | 20:30:40:10 | | PS:0.4% |
| | | | DTD:1% |
| Example 5 | EC:DEC: PP:M3 = | LiPF₆:14.5% | A1:1.0% |
| | 20:30:40:10 | | PS:0.4% |
| | | | DTD:1% |
| Example 6 | EC:DEC: PP:M3 = | LiPF₆:14.5% | A1:1.5% |
| | 20:30:40:10 | | PS:0.4% |
| | | | DTD:1% |
| Example 7 | EC:DEC: PP:M1 = | LiPF₆:14.5% | A1:1.5% |
| | 20:30:40:10 | | PS:0.4% |
| | | | DTD:1% |
| Example 8 | DEC: PP:M3 = | LiPF₆:14.5% | A1:1.5% |
| | 50:40:10 | | PS:0.4% |
| | | | DTD:1% |
| Example 9 | EC:DEC: PP:M3 = | LiPF₆:14.5% | A1:1.5% |
| | 20:25:45:10 | | PS:0.4% |
| | | | DTD:1% |
| Example 10 | EC:DEC: PP:M3 = | LiPF₆:14.5% | A1:1.5% |
| | 20:30:35:15 | | PS:0.4% |
| | | | DTD:1% |
| Example 11 | EC:DEC: PP:M3 = | LiPF₆:14.5% | A1:1.5% |
| | 20:20:45:15 | | PS:0.4% |
| | | | DTD:1% |
| Example 12 | EC:DEC: PP:M3 = | LiPF₆:14.5% | A1:1.5% |
| | 30:30:20:20 | | PS:0.4% |
| | | | DTD:1% |
| Example 13 | N1:X2: Y1:M3 = | LiPF₆:14.5% | A1:1.5% |
| | 20:30:40:10 | | PS:0.4% |
| | | | DTD:1% |
| Example 14 | EC:DEC: PP:M3 = | LiPF₆:14.5% | A1:1.5% |
| | 20:30:40:10 | | FEC:0.4% |
| | | | DTD:1% |
| Example 15 | EC:DEC: PP:M3 = | LiPF₆:14.5% | A1:1.5% |
| | 30:35:25:10 | | PS:0.4% |
| | | | DTD:1% |
| Comparative | EC:DEC: PP:M3 = | LiPF₆:14.5% | PS:0.4% |
| Example 1 | 20:30:40:10 | | DTD:1% |
| Comparative | EC:DEC: PP: DME = | LiPF₆:14.5% | A1:1.5% |
| Example 2 | 20:30:40:10 | | PS:0.4% |
| | | | DTD:1% |
| Comparative | EC:DEC: PP:M3 = | LiPF₆:14.5% | SN:1.5% |
| Example 3 | 20:30:40:10 | | PS:0.4% |
| | | | DTD:1% |
| Comparative | EC:DEC: PP: DME = | LiPF₆:14.5% | PS:0.4% |
| Example 4 | 20:30:40:10 | | DTD:1% |
| Comparative | EC:DEC: PP:M3 = | LiPF₆:14.5% | A1:1.5% |
| Example 5 | 15:20:45:20 | | PS:0.4% |
| | | | DTD:1% |
| Comparative | EC:DEC: PP:M3 = | LiPF₆:14.5% | A1:1.5% |
| Example 6 | 30:35:30:5 | | PS:0.4% |
| | | | DTD:1% |
| Comparative | EC:DEC: PP:M3 = | LiPF₆:14.5% | A1:5% |
| Example 7 | 20:30:40:10 | | PS:0.4% |
| | | | DTD:1% |
| Comparative | EC:DEC: PP:M3 = | LiPF₆:14.5% | A1:0.5% |
| Example 8 | 20:35:30:25 | | PS:0.4% |
| | | | DTD:1% |
| Comparative | EC:DEC: PP:M3= | LiPF6:14.5% | A1:0.2% |
| Example 9 | 20:30:40:10 | | PS:0.4% |
| | | | DTD:1% |

The electrolytes obtained in Examples 1 to 15 and Comparative Examples 1 to 9 were each used in lithium-ion batteries.

### Fabrication of Lithium-Ion Batteries:

1) Positive electrode: An active material LiCoO₂ (manufacturer: XTC New Energy Materials (Xiamen) Co., Ltd.), a lithium replenishing agent Li₅FeO₄, a conductive additive Super P, and PVDF were mixed in a weight ratio of 96:1.7:1.3:1, then N-methylpyrrolidone (NMP) was added, and thorough mixing was conducted to produce a positive-electrode slurry for a lithium-ion battery. The positive-electrode slurry was coated on two sides of an aluminum foil current collector, and a product was oven-dried at 85° C., cold-pressed, trimmed, cut, slitted, and oven-dried for 4 h under vacuum at 85° C. Then a tab was welded to produce a positive electrode for the lithium-ion battery.
2) A negative electrode was a lithium metal negative electrode.
3) Assembly of pouch cells: The prepared positive electrode, separator, and negative electrode were arranged sequentially with the separator between the positive and negative electrodes, and winding was conducted to produce a bare cell. The bare cell was placed in an aluminum-plastic film packaging. The prepared electrolyte was injected into a dried battery, and sealing, standing, formation, shaping, and capacity grading were conducted to produce a lithium-ion battery.

The lithium-ion batteries obtained in Examples 1 to 15 and Comparative Examples 1 to 9 were each subjected to electrochemical performance tests.

### Performance Tests:

1) Cycling performance test at room temperature: In an environment at 25° C., a battery produced after the capacity grading was charged at a constant current and voltage of 0.7 C to 4.45 V with a cut-off current of 0.05 C, and then discharged at a constant current of 0.5 C to 3.0 V. 500 charge-discharge cycles were conducted. Then a 500th-cycle capacity retention rate was calculated according to the following calculation formula:

500th-cycle capacity retention rate (%)=(discharge capacity of the 500th cycle/discharge capacity of the first cycle)×100%.
2) 14 d high-temperature storage test at 60° C.: A battery was charged and discharged once at 0.5 C and room temperature (4.45 V to 3.0 V). A discharge capacity C₀ of the battery before storage was recorded. Then, the battery was charged at a constant current and voltage to a fully charged state of 4.45 V. A thickness d₁ of the battery before high-temperature storage was measured with a PPG battery thickness gauge (500 g). The battery was stored in a 60° C. thermostatic chamber for 14 d. After the 14 d storage, the battery was taken out, and a high-temperature thickness d₂ of the battery after the storage was measured. A thickness expansion rate of the battery after the 14 d storage at 60° C. was calculated. After the battery was cooled at room temperature for 24 h, the battery was discharged at a constant current of 0.5 C to 3.0 V and then charged at a constant current and voltage of 0.5 C to 4.45 V. A discharge capacity C₁ and a charge capacity C₂ of the battery after the storage were recorded. The capacity retention rate and the capacity recovery rate of the battery after the 14 d storage at 60° C. were calculated. The corresponding calculation formulas were as follows:

thickness expansion rate after 14 d storage at 60° C.=(d₂−d₁)/d₁*100%;

capacity retention rate after 14 d storage at 60° C.=(C₁/C₀)*100%; and

capacity recovery rate after 14 d storage at 60° C.=(C₂/C₀)*100%.
3) Direct current resistance (DCR) test: At room temperature (23° C.±3° C.), a battery was charged at a constant current and voltage of 0.5 C to 4.45 V with a cut-off current of 0.02 C, and then discharged at 0.1 C for 9 h (adjusted to 10% SOC). Then the battery was discharged at 0.1 C for 10 s, and a corresponding end voltage was denoted as V1. The battery was further discharged at 1 C for 1 s, and a corresponding end voltage was denoted as V2. A calculation formula was as follows:

DCR=(V1−V2)/(1 C−0.1 C).
4) Thermal shock performance test: In a 25° C. environment, a battery was discharged at a given current of 0.2 C to 3.0 V, allowed to rest for 5 min, and charged at a charging current of 0.2 C to 4.45 V. When a cell voltage reached 4.45 V, the charging was continued at a constant voltage of 4.45 V until a charging current was less than or equal to a given cut-off current of 0.05 C. A cell was allowed to rest for 1 h, then placed in an oven, heated at a heating rate of 5±2° C./min to 135±2° C., and kept at this temperature for 30 min. The test was ten stopped. A determination criterion was that a cell did not catch fire or explode.

Experimental results were shown in Table 2.

TABLE 2

| | Capa- | | Thick- | Capa- | Capa- |
|---|---|---|---|---|---|
| | city | | ness | city | city |
| | reten- | | expan- | reten- | recov- |
| | tion | | sion | tion | ery |
| | rate | | rate | rate | rate |
| | after | | after | after | after |
| | 500 | Ther- | 60° | 60° | 60° |
| | room- | mal | C./ | C./ | C./ |
| | temp- | shock | 14 d | 14 d | 14 d |
| | erature | at | stor- | stor- | stor- |
| | cycles/ | 135° | age/ | age/ | age/ |
| Test item | % | C. | % | % | % |
| Example 1 | 96.6% | 6/6pass | 3.8% | 90.7% | 92.5% |
| Example 2 | 96.1% | 6/6pass | 4.2% | 88.5% | 91.1% |
| Example 3 | 95.8% | 6/6pass | 3.9% | 88.8% | 90.9% |
| Example 4 | 96.2% | 6/6pass | 4.2% | 89.3% | 91.5% |
| Example 5 | 96.9% | 6/6pass | 3.5% | 90.6% | 93.1% |
| Example 6 | 94.3% | 6/6pass | 4.7% | 86.3% | 90.2% |
| Example 7 | 92.6% | 6/6pass | 6.2% | 83.2% | 86.4% |
| Example 8 | 93.4% | 6/6pass | 5.2% | 84.6% | 88.2% |
| Example 9 | 91.2% | 5/6pass | 6.4% | 80.4% | 82.6% |
| Example 10 | 93.4% | 6/6pass | 5.1% | 84.2% | 87.6% |
| Example 11 | 88.4% | 6/6pass | 6.2% | 79.3% | 80.1% |
| Example 12 | 88.6% | 6/6pass | 7.3% | 80.2% | 81.3% |
| Example 13 | 92.4% | 6/6pass | 5.2% | 84.3% | 89.4% |
| Example 14 | 92.6% | 6/6pass | 5.3% | 84.6% | 89.3% |
| Example 15 | 92.8% | 5/6pass | 6.8% | 85.2% | 88.5% |
| Comparative | 80.2% | 3/6pass | 13.8% | 60.4% | 72.4% |
| Example 1 | | | | | |
| Comparative | 81.9% | 4/6pass | 12.6% | 62.9% | 76.0% |
| Example 2 | | | | | |
| Comparative | 83.1% | 4/6pass | 14.5% | 59.0% | 75.9% |
| Example 3 | | | | | |
| Comparative | 76.7% | 0/6pass | 17.2% | 52.1% | 65.3% |
| Example 4 | | | | | |
| Comparative | 83.4% | 5/6pass | 10.3% | 75.3% | 78.4% |
| Example 5 | | | | | |
| Comparative | 81.2% | 4/6pass | 12.8% | 70.2% | 77.1% |
| Example 6 | | | | | |
| Comparative | 83.5% | 5/6pass | 10.5% | 75.5% | 78.2% |
| Example 7 | | | | | |
| Comparative | 80.7% | 4/6pass | 13.6% | 71.4% | 76.2% |
| Example 8 | | | | | |
| Comparative | 82.1% | 3/6pass | 12.9% | 72.0% | 76.9% |
| Example 9 | | | | | |

It can be seen from the comparison of results of Examples 1 to 15 and Comparative Examples 1 to 9 that, when both a fluoroether solvent and a tetranitrile additive are added in the electrolyte of the present disclosure and the contents of the fluoroether, the carbonate compound, and the carboxylic ester are controlled within the respective ranges, the use of the electrolyte system in combination with a lithium metal negative electrode-based lithium-ion battery can effectively mitigate the generation of lithium dendrites at a lithium metal negative electrode and can also stabilize both positive and negative electrodes, thereby enhancing the cycling performance, high-temperature performance, and safety of the lithium metal negative electrode-based lithium-ion battery.

It can be seen from the comparison of Examples 1 and 5 to 6 with Comparative Examples 5 to 9 that, when the content of the tetranitrile additive is adjusted under the premise of controlling the fluoroether, the carbonate compound, and the carboxylic ester at specified contents, a corresponding lithium metal negative electrode-based lithium-ion battery exhibits prominent cycling performance, high-temperature performance, and safety. In particular, when the mass ratio of the fluoroether, the carbonate compound, and the carboxylic ester is 10:50:40, 0.5 wt % of the tetranitrile additive can make a corresponding battery demonstrate superior performance. When tetranitrile additives with different molecular structures are adopted at this mass ratio, corresponding lithium metal negative electrode-based lithium-ion batteries also exhibit relatively prominent cycling performance, high-temperature performance, and safety, as evidenced by the test results of Examples 1 to 4.

Additionally, the comparison between Example 6 and Examples 9 to 12 shows that, when the tetranitrile additive is selected with the mass ratio of the fluoroether, the carbonate compound, and the carboxylic ester controlled at 10:50:40, corresponding lithium metal negative electrode-based lithium-ion batteries exhibit relatively prominent cycling performance, high-temperature performance, and safety. The inventors have verified through multiple tests that, when the mass proportion of the fluoroether in the electrolyte is less than the mass proportion of the carboxylic ester in the electrolyte and the mass proportion of the carboxylic ester in the electrolyte is less than the mass proportion of the carbonate compound in the electrolyte, it is favorable for enhancing the overall performance of the battery, including cycling stability, thermal stability, and safety.

In summary, the electrolyte provided by the present disclosure exhibits excellent compatibility with lithium metal negative electrode-based lithium-ion batteries, and can effectively improve the cycling performance, high-temperature performance, and safety for these batteries, thereby extending the service life for these batteries.

According to the disclosure and teaching of the above specification, those skilled in the field of the present disclosure may also change and modify the above embodiments. Therefore, the present disclosure is not limited to the above specific embodiments, and any obvious improvements, replacements, or modifications made by those skilled in the art on the basis of the present disclosure should fall within the protection scope of the present disclosure. In addition, although some specific terms are used in the specification, these terms are provided to merely illustrate rather than limit the present disclosure.

What is claimed is:

1. An electrolyte, comprising a solvent, a lithium salt, and an additive, wherein the solvent comprises a fluoroether, a carbonate compound, and a carboxylic ester in a mass ratio of (10-20):(40-65):(20-45);
the additive comprises a first additive, and the first additive is a tetranitrile compound represented by formula I: 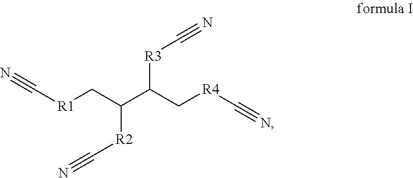
wherein R₁, R₂, R₃, and R₄ are each independently selected from the group consisting of substituted or unsubstituted C₁-C₁₀ alkyl or alkoxy, C₂-C₁₀ alkenyl or alkenoxy, C₂-C₁₀ alkynyl or alkynoxy, and a group with one or more heteroatoms of N, S, and O, and when there is a substitution, a substituent is a fluorine (F) atom; and
when a mass proportion of the fluoroether in the electrolyte is a %, a mass proportion of the carbonate compound in the electrolyte is b %, a mass proportion of the carboxylic ester in the electrolyte is c %, and a mass proportion of the first additive in the electrolyte is d %, the following relational expression is satisfied: (a+b+c)*3%≥d≥(a+b+c)*0.5%.

2. The electrolyte according to claim 1, wherein the mass proportion of the fluoroether in the electrolyte is less than the mass proportion of the carboxylic ester in the electrolyte; and the mass proportion of the carboxylic ester in the electrolyte is less than the mass proportion of the carbonate compound in the electrolyte.

3. The electrolyte according to claim 1, wherein a sum of the mass proportions of the fluoroether, the carbonate compound, and the carboxylic ester in the electrolyte is greater than or equal to 50%.

4. The electrolyte according to claim 1, wherein the carbonate compound is a fluorinated or non-fluorinated carbonate compound; and the carboxylic ester is a fluorinated or non-fluorinated carboxylic ester.

5. The electrolyte according to claim 4, wherein the fluoroether has a structural formula of 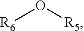
the carboxylic ester has a structural formula of 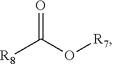
and the carbonate compound has a structural formula of 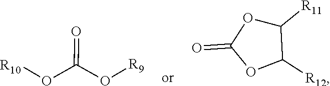
wherein R₅ and R₆ are each independently selected from the group consisting of fluorinated C₁-C₁₀ alkyl or alkoxy, fluorinated C₂-C₁₀ alkenyl or alkenoxy, and fluorinated C₂-C₁₀ alkynyl or alkynoxy; and R₇ to R₁₂ are each independently selected from the group consisting of fluorinated or non-fluorinated C₁-C₁₀ alkyl or alkoxy, fluorinated or non-fluorinated C₂-C₁₀ alkenyl or alkenoxy, and fluorinated or non-fluorinated C₂-C₁₀ alkynyl or alkynoxy.

6. The electrolyte according to claim 1, wherein the first additive is any one selected from the group consisting of the following structural formulas:

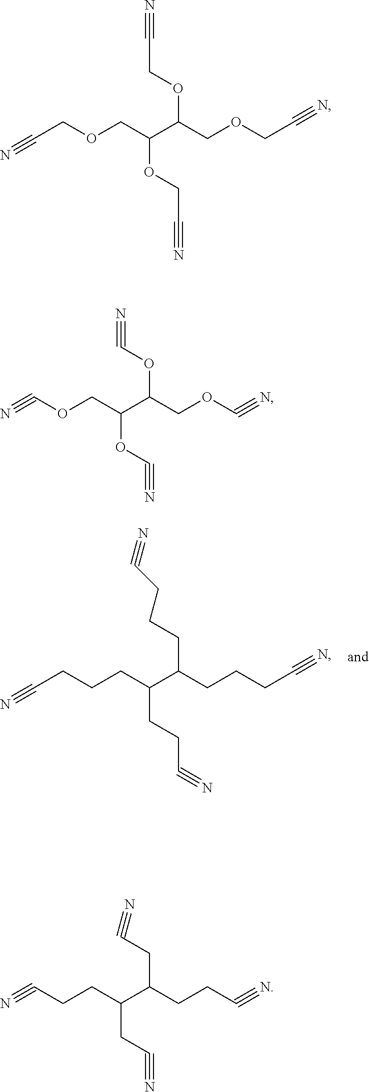

7. The electrolyte according to claim 1, wherein the additive further comprises a second additive; the second additive is at least one selected from the group consisting of 1,3-propane sultone (PS), 1,3,2-dioxathiolane-2,2-dioxide (DTD), fluoroethylene carbonate (FEC), tris(trimethylsilyl) borate (TMSB), and tris(trimethylsilyl)phosphate (TMSP); and a mass proportion of the second additive in the electrolyte is 0.1% to 10%.

8. The electrolyte according to claim 1, wherein the lithium salt is at least one selected from the group consisting of lithium hexafluorophosphate, lithium difluorophosphate, lithium difluoro (oxalato)phosphate, lithium tetrafluoro (oxalato)phosphate, lithium bis(oxalate) borate, lithium difluorooxalate borate, lithium tetrafluoroborate, lithium bis(trifluoromethanesulfonyl)imide, lithium trifluoromethanesulfonate, lithium perchlorate, and lithium bis(fluorosulfonyl)imide, and a mass proportion of the lithium salt in the electrolyte is 0.1% to 25%.

9. A secondary battery, comprising a positive electrode, a negative electrode, a separator arranged between the positive electrode and the negative electrode, and an electrolyte, wherein the electrolyte is the electrolyte according to claim 1, and the negative electrode is a lithium metal negative electrode.

10. An electric device comprising the secondary battery according to claim 9.
